(19) United States
(12) Patent Application Publication
(10) Pub. No.: US 2004/0081511 A1
(43) Pub. Date: Apr. 29, 2004

(54) Attachment for a rotating part

(76) Inventors: Clifford B. Willis, Tracy, CA (US); Robert J. Lajara, San Jose, CA (US)

Correspondence Address: BRIAN M BERLINER, ESQ, O'MELVENY & MYERS, LLP, 400 SOUTH HOPE STREET, LOS ANGELES, CA, 90071-2899, US

(21) Appl. No.: 10/639,334

(22) Filed: Aug. 11, 2003

Related U.S. Application Data
(60) Provisional application No. 60/420,931, filed on Oct. 24, 2002.

(51) Int. Cl. F16B 1/00; E05D 1/00

(52) U.S. Cl. 403/279; 16/221

(57) ABSTRACT

A riveted attachment for a rotating part, such as for a swiveling handle, is provided using a rivet and two parallel pieces of sheet material. A cylindrical raised dimple with a central through hole is formed in a first piece of sheet material. The dimple is inserted through a hole in the second piece of sheet material. A rivet is inserted through the dimple and swaged against opposite ends of the dimple, trapping the second piece of material while leaving it free to rotate around the cylindrical axis of the dimple.

### CROSS-REFERENCE TO RELATED APPLICATION

This application claims priority pursuant to 35 U.S.C. § 119(e) to U.S. Provisional Application No. 60/420,931, filed Oct. 24, 2002, which application is specifically incorporated herein, in its entirety, by reference.

### BACKGROUND OF THE INVENTION

1. Field of the Invention

The present invention relates to structures made from rigid formable sheet materials, such as sheet metals, and more particularly to a structure for attaching a rotating part to a sheet-material structure.

2. Description of Related Art

It is frequently desirable to attach a rotating part, such as a handle, to sheet metal structures such as computer enclosures and the like. In particular, it may be desirable to attach a rotating handle to a removable drawer that can be slid into and out of a larger enclosure, such as a computer chassis or cabinet. At the same time, it is desirable to minimize the number of parts and assembly time needed to make the attachment.

Rivets are frequently used to attach sheet metal parts together. When used to attach a rotating handle to a drawer, however, rivets may create a problem with compression, interference and rubbing of adjacent parts. Spacers may be used to maintain clearance between adjacent moving parts, but these introduce additional cost and assembly time. Shoulder screws may be used, but are relatively expensive, increase assembly time, and are susceptible to becoming loose or unscrewed. It is therefore desirable to provide an attachment for a rotating handle or other part that can be used to connect sheet material parts using a rivet, without using any additional spacers, shoulder screws, or other such parts.

### SUMMARY OF THE INVENTION

The present invention provides an attachment for attaching a rotating part, such as a handle, to another structure. The attachment is suitable for use with sheet metal parts and rivets, and does not require the use of additional parts to maintain clearance between the attached parts. In addition, the attachment may be adapted for use with other fasteners, such as machine screws.

The present invention provides a rotating attachment comprising a rivet or other fastener, and an extruded through hole in the sheet material of the part that the rotating part is to be attached to, herein called the “attached part”. First, a through hole is formed in the sheet material, and then extruded to form a cylindrical dimple with a circular central through hole. The height of the dimple is greater than the thickness of the rotating part to which it is attached. A through hole is also present in the rotating part. The hole in the rotating part has an inner diameter greater than the outer diameter of the dimple, and functions as a bearing for the rotating part. The dimple is inserted through the hole in the rotating part, and the rotating part and attached part are riveted together. The end result is a structure wherein the rotating part is trapped between the head of the rivet and the attached part, and is free to rotate around the dimple. The rotating parts are retained but not clamped together, because the rivet is swaged only against opposite ends of the dimple. The dimple also maintains adequate clearance between the rotating part and the attached part. These attributes of the attachment may be useful, for example, for free rotation of a handle. The attachment structure may optionally include a recess in the attached part, for ensuring that the rivet or other fastener used for the attachment is flush with, or below, a surface of the attached part.

A more complete understanding of the invention will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1A is a perspective view of an exemplary rotating handle attached to a front panel of a sheet metal structure, according to an embodiment of the invention. The handle is in an unextended position.

FIG. 1B is the same view as FIG. 1A, but with the handle in an extended position.

FIG. 2 is a detail perspective view showing a first side of an exemplary attachment for the handle shown in FIG. 1, according to an embodiment of the invention.

FIG. 3 is a detail perspective view showing a second side of an exemplary attachment for the handle shown in FIG. 1, according to an embodiment of the invention.

FIG. 4 is a detail plan showing a first side of an exemplary attachment for the handle shown in FIG. 1.

FIG. 5 is a detail cross-sectional view showing the attachment shown in the foregoing figures.

### DETAILED DESCRIPTION OF THE PREFERRED EMBODIMENT

The present invention provides an attachment for a rotating handle that overcome the limitations of the prior art. In the detailed description that follows, like element numerals are used to indicate like elements appearing in one or more of the figures.

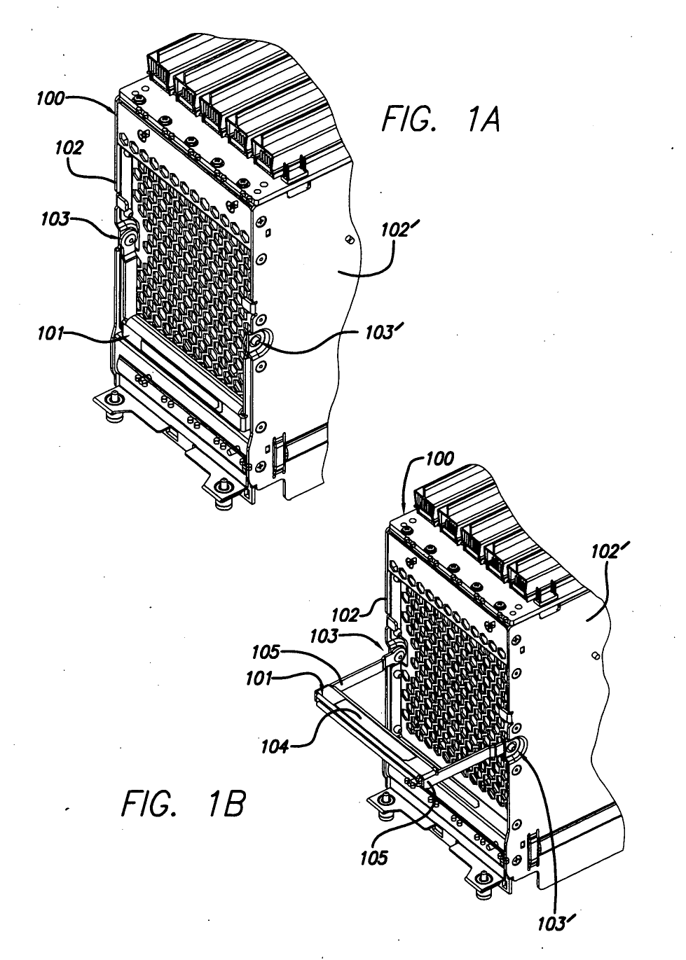

Referring to FIGS. 1A-1B, an exemplary application for the attachment is shown, comprising a sheet metal structure 100 with sheet metal side panels 102, 102′ to which a handle 101 is attached by attachments 103, 103′. Attachments 103, 103′ are substantially identical. Structure 100 may comprise a housing for an electronic component—in this case, a modular component designed to slide into a cabinet—but an attachment according to the invention may be used for any suitable application. The details of structure 100 are not a feature of the invention, except for attachments 103, 103′ and their application. Accordingly, only those portions of structure 100 which show these elements are depicted.

Handle 101 is a pull handle for structure 100, and comprises a grab bar 104 and two extending arms 105, one on each side of the grab bar. The handle is configured to lay flush with the front panel of structure 100 between side panels 102, 102′ when in a resting position, as shown in FIG. 1A. From this position, the handle may be rotated around its attachments 103, 103′ to the extended position shown in FIG. 1B, and used as a pull handle. Attachments 103, 103′ permit free rotation of handle 101 around an axis though the centers of both attachments, and also transmit shear forces (such as from pulling on the handle) between the handle and side panels 102, 102′. It should be apparent that attachment 103 may be used to attach any two parts, especially sheet metal parts, that should freely rotate with respect to one another while permitting transfer of shear forces. Further details of the attachments are described below.

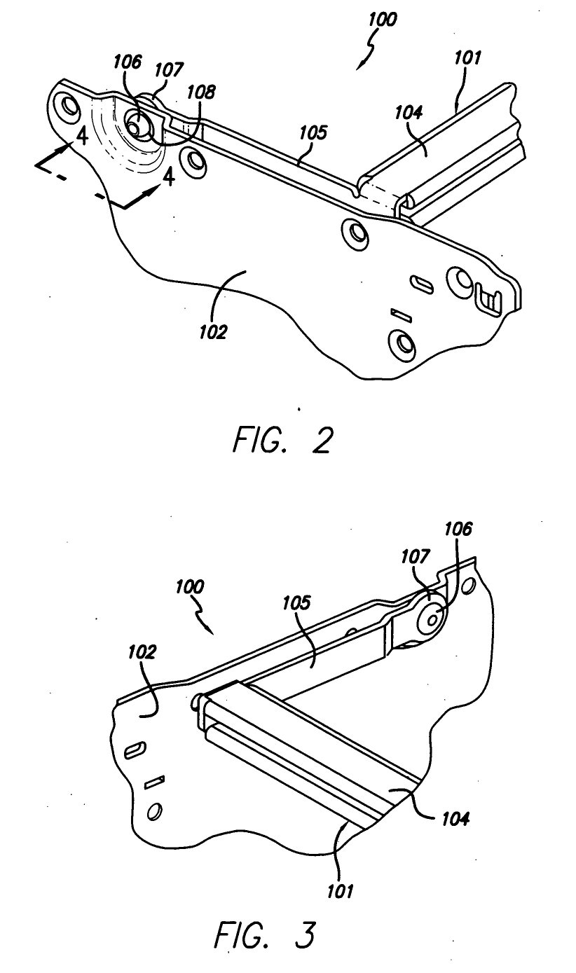

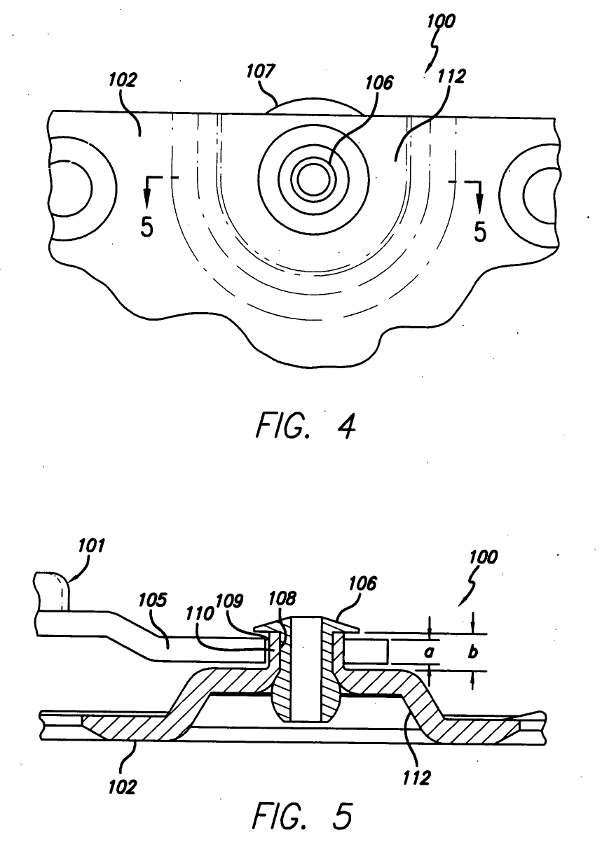

Referring to FIGS. 2-5, showing attachment 103 and adjacent portions of the side panel 102 and handle 101, attachment 103 comprises rivet 106, dimple 110, and through hole 108. Dimple 110 is in the form of a hollow cylinder having its cylindrical axis perpendicular to the side panel. Through hole 109 in bearing 107 of handle arm 105 is formed for a loose clearance fit with respect to the outside diameter of dimple 110. Dimple 110 is inserted through the clearance hole 109 in bearing 107. Rivet 106 is inserted through hole 108 in dimple 110 and swaged in place against opposite ends of the dimple. For example, the rivet head may rest against a distal portion of the dimple at one end, and the rivet may be swaged underneath the dimple and panel 102 at the opposite end, as shown. The dimple extends past the bearing 105. Thus, rivet 106 retains bearing 107 under the rivet head, without compressing the bearing 105 and the side panel 102 together.

Any suitable rivet may be used, as known in the art. In the illustrated embodiment, rivet 106 is a conventional hollow rivet. It is preferable that the rivet pass readily through the hollow core of dimple 110 during assembly, and substantially fill the core after being swaged. The rivet and swaging pressure should be selected so that dimple 110 is not compressed past its yield point. Conversely, the rivet should provide enough compression to ensure that the rivet remains snug (i.e., in tension) during use. Like riveted connections generally, the attachment should be designed so that the rivet is primarily loaded in shear. However, unlike prior-art riveted connections such as traditionally used for shear panels and structural skins, the rivet remains in tension and retains the riveted sheets without clamping them together. This is accomplished without any need for special rivets, fasteners, or auxiliary components. The entire attachment can be accomplished merely using the two sheets to be attached and a conventional rivet.

Dimple 110 may be formed by any suitable method. In the illustrated embodiment, side panel 102 comprises a mild steel (low carbon steel) sheet material. Accordingly, it is preferable to form dimple 110 using a suitable forming tool to deform the sheet material around hole 108, such as by extruding. Suitable forming methods are known in the art. Generally, the parameters of interest in forming dimple 110 include the inside diameter of hole 108, the outside cylindrical diameter of dimple 110, and the dimple height, indicated as dimension “b” on FIG. 5. It should be possible to control at least two of these parameters, while the third parameter will be a function of the initial geometry and the other two parameters. For example, in forming a dimple 110 with a through hole 108 in a 1.50 mm thick mild steel sheet, a dimple having a wall thickness of 0.65 mm may readily be formed. The height of the dimple “b” should be greater than the thickness “a” of the bearing material. Because the divot extends past bearing 107, it is not compressed by the rivets. Accordingly, cylindrical dimple 110 functions as a journal or hub, around which arm 105 with its captured bearing 107 is free to rotate. Advantageously, the cylindrical sleeve of dimple 110 cooperates with the rivet to bolster the shear strength of the riveted attachment.

Optionally, attachment 103 may be offset from a surface of side plate 102 by forming a recess 112 in the side plate. Recess 112 may be formed in the same operation as dimple 110, and provides clearance for the swaged end of rivet 106, so that it does not protrud from the side plate. However, recess 112 is not required for proper functioning of attachment 103.

In the alterative, the rotating handle may be formed by dimpling the bearing 107 of the handle arm 105 in the manner described above for side panel 102, instead of the side panel. A hollow cylindrical hub formed by dimpling the handle bearing may be inserted through a clearance hole in the side panel, and the side panel and the handle bearing riveted together in any suitable manner, as described above. This alternative embodiment is merely the converse of the configuration shown in FIG. 5. One of ordinary skill will recognize that the essential function of the rotating attachment is the same, whether (with reference to FIG. 5) the dimple 110 is in the side panel 102 (as shown), or in the handle bearing 107 (not shown).

Having thus described a preferred embodiment of the invention, it should be apparent to those skilled in the art that certain advantages of the within system have been achieved. It should also be appreciated that various modifications, adaptations, and alternative embodiments thereof may be made within the scope and spirit of the present invention. For example, a particular size and shape of attachment has been illustrated, but it should be apparent that the inventive concepts described above would be equally applicable to other sizes and shapes of attachments that incorporate the inventive concepts described above. For further example, an attachment for a handle has been illustrated, but it should be apparent that the same attachment would work for many other types of rotating parts. The invention is further described by the following claims.

What is claimed is:

1. An attachment for substantially parallel sheets of material, the attachment comprising:
two substantially parallel sheets;
a hollow cylindrical extrusion formed from a first one of the two sheets and protruding therefrom through a hole in a second one of the two sheets, a distal end of the cylindrical extrusion protruding past the second sheet; and
a rivet passing through the cylindrical extrusion and swaged against opposite ends thereof, the rivet attaching the two sheets together while permitting the two sheets to rotate freely with respect to one another around an axis of the cylindrical extrusion.

2. The attachment of claim 1, wherein the two parallel sheets comprise sheets of a metallic material.

3. The attachment of claim 2, wherein the metallic material comprises steel.

4. The attachment of claim 1, wherein the cylindrical extrusion is positioned in a recessed area of the first one of the two sheets.

5. The attachment of claim 1, wherein the rivet comprises a hollow rivet.

6. The attachment of claim 1, wherein at least one of the two sheets is connected to a handle, whereby the attachment is for a rotating handle.

7. An attachment for a rotating part, the attachment comprising:
two substantially parallel sheets;
a cylindrical dimple formed from a first one of the two sheets and protruding therefrom through a hole in a second one of the two sheets; and
a rivet passing through the cylindrical dimple and swaged against opposite ends of the dimple without contacting the second one of the two sheets, the rivet attaching the two sheets together while permitting the two sheets to rotate freely with respect to one another around an axis of the cylindrical dimple.

8. The attachment of claim 7, wherein the two parallel sheets comprise sheets of a metallic material.

9. The attachment of claim 8, wherein the metallic material comprises steel.

10. The attachment of claim 7, wherein the cylindrical dimple is positioned in a recessed area of the first one of the two sheets.

11. The attachment of claim 7, wherein the rivet comprises a hollow rivet.

12. The attachment of claim 7, wherein at least one of the two sheets is connected to a handle, whereby the attachment is for a rotating handle.

13. A structure comprising:
two spaced-apart opposing walls of a sheet metal housing; and
a handle spanning the two opposing walls, each of opposing ends of the handle attached to respective ones of the two opposing walls by respective ones of two attachments, wherein:
each of the two attachments comprises two substantially parallel sheet portions, a first of the two sheet portions integrated to the handle, a second of the two sheet portions integrated to a respective one of the two opposing walls, a cylindrical dimple protruding from either of the two sheet portions and inserted through a hole of another of the sheet portions, a rivet passing through the cylindrical dimple and swaged against opposite ends of the dimple, thereby attaching the two sheet portions together while permitting the two sheet portions to rotate freely with respect to one another around an axis of the cylindrical dimple.

14. The structure of claim 13, wherein the cylindrical dimple is positioned in the first one of the two sheet portions.

15. The structure of claim 13, wherein the cylindrical dimple is positioned in the second one of the two sheet portions.

16. The structure of claim 13, wherein the cylindrical dimple is positioned in a recessed area of one of the two sheet portions.

17. The structure of claim 13, wherein the handle comprises a sheet metal piece between the opposing ends of the handle.

18. The structure of claim 13, further comprising an electronic component disposed inside the sheet metal housing.

19. The structure of claim 17, wherein the sheet metal housing, wherein the sheet metal housing is configured for sliding into a rack for electronic components.

20. The structure of claim 13, wherein the rivet comprises a hollow rivet.
